(19) United States
(12) Patent Application Publication
(10) Pub. No.: US 2025/0012584 A1
(43) Pub. Date: Jan. 9, 2025

(54) MOBILE ENTITY CONTROL DEVICE, AND MOBILE ENTITY CONTROL METHOD

(71) Applicant: Panasonic Automotive Systems Co., Ltd., Kanagawa (JP)

(72) Inventors: Takumi SASADA, Osaka (JP); Hideaki TAKECHI, Osaka (JP); Mitsuteru KATAOKA, Osaka (JP); Kouichi KANEMURA, Osaka (JP)

(73) Assignee: Panasonic Automotive Systems Co., Ltd., Kanagawa (JP)

(21) Appl. No.: 18/893,359

(22) Filed: Sep. 23, 2024

Related U.S. Application Data
(63) Continuation of application No. PCT/JP2022/047068, filed on Dec. 21, 2022.

(30) Foreign Application Priority Data
Mar. 30, 2022 (JP) 2022-055139

(51) Int. Cl. G01C 21/34; B60W 60/00; H04W 24/08

(52) U.S. Cl. CPC G01C 21/3461; B60W 60/001; H04W 24/08; B60W 2555/20; B60W 2556/40; B60W 2556/45

(57) ABSTRACT

A mobile entity control device includes a communicator for communicating with a mobile entity capable of autonomous driving, a communication quality measurer that measures communication quality of communication with the mobile entity via the communicator, a determiner that determines a risk level of specific locations in a predetermined driving route along which the mobile entity travels, and a controller that generates driving control information for controlling travel of the mobile entity based on the communication quality and the risk level, and transmits the driving control information to the mobile entity via the communicator.

### CROSS REFERENCE TO RELATED APPLICATIONS

This is a continuation application of PCT International Application No. PCT/JP2022/047068 filed on Dec. 21, 2022, designating the United States of America, which is based on and claims priority of Japanese Patent Application No. 2022-055139 filed on Mar. 30, 2022.

### FIELD

The present disclosure relates to a mobile entity control device that controls a mobile entity capable of autonomous driving, and a mobile entity control method.

### BACKGROUND

Traditionally, there are devices that control mobile entities capable of autonomous driving, such as autonomous driving vehicles (for example, see Patent Literature (PTL) 1). PTL 1 discloses a device that is installed in a vehicle, and calculates a delay time of communication with an external terminal. When the delay time calculated is equal to or greater than a predetermined value, the device generates a driving plan of autonomous driving of a vehicle by setting a limit vehicle speed value indicating a speed of the vehicle such that the limit vehicle speed value is set smaller as the delay time is longer and the limit vehicle speed value is set with a smaller change rate as the delay time is longer. Thereby, autonomous driving of the vehicle is implemented with high safety.

### CITATION LIST

### Patent Literature

PTL 1: Japanese Unexamined Patent Application Publication No. 2021-18563

### SUMMARY

However, the device according to the above-described PTL 1 can be improved upon.

In view of this, the present disclosure provides a mobile entity control device etc., capable of improving upon the above related art.

The mobile entity control device according to one aspect of the present disclosure includes a communication circuit that communicates with a mobile entity capable of autonomous driving; a communication quality measurement circuit that measures communication quality of communication with the mobile entity via the communication circuit; a determination circuit that determines a risk level of specific locations in a predetermined driving route along which the mobile entity travels; and a control circuit that generates driving control information for controlling travel of the mobile entity based on the communication quality and the risk level, and transmits the driving control information to the mobile entity via the communication circuit.

These general or specific aspects may be implemented by a system, a method, an integrated circuit, a computer program, or a recording medium such as a computer-readable CD-ROM, or may be implemented by any combination of systems, methods, integrated circuits, computer programs, and recording media.

The mobile entity control device etc., according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram schematically illustrating the mobile entity control system according to an embodiment.

FIG. 2 is a block diagram illustrating the configuration of the mobile entity control device according to the embodiment.

FIG. 3 is a diagram for illustrating a specific example of determination processing by the determiner according to the embodiment.

FIG. 4 is a flowchart illustrating a processing procedure of the mobile entity control device according to the embodiment.

### DESCRIPTION OF EMBODIMENT

### Summary of the Present Disclosure

Traditionally, there are devices that control mobile entities capable of autonomous driving, such as autonomous driving vehicles. An improvement in safety during autonomous driving is desired for the mobile entity of this type. On the other hand, safety excessively weighed may cause frequent deceleration, stop or emergency stop of the mobile entity, and obstacles to smooth travel of the mobile entity may not be removed.

The present disclosure provides a mobile entity control device that can suppress obstacles to smooth travel of a mobile entity, and can improve safety of autonomous driving of the mobile entity.

The mobile entity control device according to one aspect of the present disclosure includes a communicator that communicates with a mobile entity capable of autonomous driving; a communication quality measurer that measures communication quality of communication with the mobile entity via the communicator; a determiner that determines a risk level of specific locations in a predetermined driving route along which the mobile entity travels; and a controller that generates driving control information for controlling travel of the mobile entity based on the communication quality and the risk level, and transmits the driving control information to the mobile entity via the communicator.

In such a configuration, the travel of the mobile entity, that is, autonomous driving of the mobile entity can be controlled using not only the communication quality in communication between the mobile entity control device and the mobile entity but also the risk level (the degree of risk) of a location through which the mobile entity travels (passes). For this reason, compared to the traditional device that controls autonomous driving of the mobile entity in consideration of only the communication quality in communication with the mobile entity, the safety of autonomous driving of the mobile entity can be improved while obstacles to smooth travel of the mobile entity is suppressed.

For example, the determiner further determines a service level of a service provided by the mobile entity, and the controller generates the driving control information based on the communication quality, the risk level, and the service level.

In some cases, the mobile entity is requested to provide a service such as delivery of a user to a destination to a predetermined time, for example. It is considered that such a service includes a case where the user should be delivered in a very short time and a case where the user is delivered with enough time to spare, and the service level required for the service is different depending on the case. Thus, by controlling the travel of the mobile entity also in consideration of the service level, an unnecessary reduction in quality of the service provided by the mobile entity, such as an unnecessary deceleration of the mobile entity, can be suppressed.

For example, the determiner determines at least one of the risk level or the service level based on past information including the driving control information from a past.

In such a configuration, when the controller generates the driving control information and the risk level and/or the service level under the same condition as that when it generated the driving control information in the past, for example, by referring to the driving control information from the past, determination precision (processing precision) of the risk level and/or determination precision of the service level can be improved, or their determination speeds (processing speeds) can be improved.

For example, the past information further includes information used to generate the driving control information.

In such a configuration, when the controller generates the driving control information and the risk level and/or the service level under the same condition as that when it generated the driving control information in the past, for example, by referring to the driving control information from the past and information used in the driving control information, the determination precision of the risk level and/or the determination precision of the service level can be improved, or these determination speeds can be improved.

For example, the determiner determines at least one of the risk level or the service level based on mobile entity information including pieces of information concerning a plurality of mobile entities with which the mobile entity control device communicates, each of the plurality of mobile entities being the mobile entity.

In such a configuration, when the driving control information of one mobile entity is generated under the same condition as that when the driving control information of another mobile entity is generated, by referring to the driving control information of another mobile entity, the determination precision of the risk level and/or the determination precision of the service level can be improved, or these determination speeds can be improved.

For example, the determiner determines at least one of the risk level or the service level based on map information indicating a map including the predetermined driving route.

In such a configuration, the risk level and/or service level can be determined in consideration of the information considered to be likely to affect the travel of the mobile entity, such as an intersection, a downgrade, a narrow road, a sharp bend, or a railroad crossing.

For example, the determiner determines at least one of the risk level or the service level based on weather information.

In such a configuration, the risk level and/or the service level can be determined in consideration of information that is likely to affect the travel of the mobile entity, such as rain or snow or a state at a low air temperature.

For example, the controller selects either the risk level or the service level based on the risk level and the service level; and generates the driving control information based on a selected one of the risk level or the service level.

For example, when the risk level is extremely low, in some cases, the safety of autonomous driving of the mobile entity can be ensured without considering the risk level. Alternatively, for example, when the requested service level is extremely low, for example, when there is an enough time to arrive at the destination, in some cases, the mobile entity can provide an appropriate service without considering the service level. Thus, by generating the driving control information in consideration of only one of the service level and the risk level, the driving control information can be generated with a reduced processing amount.

For example, the controller calculates a new driving route based on at least the selected one of the risk level or the service level; and generates the driving control information to change a driving route of the mobile entity from the predetermined driving route to the new driving route.

For example, when one driving route has the shortest distance to the destination but the mobile entity is slowed down in consideration of the risk level, for example, there are some cases where depending on the driving route, the mobile entity can arrive at the destination in a shorter time while the safety of autonomous driving thereof is ensured, for example, by causing the mobile entity to travel on another driving route. Thus, by calculating the new driving route based on at least one of the risk level or the service level, the safety of autonomous driving of the mobile entity can be improved, and the mobile entity can appropriately provide the service.

The mobile entity control method according to one aspect of the present disclosure includes measuring communication quality of communication with a mobile entity capable of autonomous driving via a communicator for communicating with the mobile entity; determining a risk level of specific locations in a predetermined driving route along which the mobile entity travels; and generating driving control information for controlling travel of the mobile entity based on the communication quality and the risk level, and transmitting the driving control information to the mobile entity via the communicator.

In such a configuration, the same effects as those of the mobile entity control device according to one aspect of the present disclosure can be obtained.

These general or aspect aspects may be implemented by a system, a method, an integrated circuit, a computer program, or a recording medium such as a computer-readable CD-ROM, or may be implemented by any combination of systems, methods, integrated circuits, computer programs, and recording media.

Hereinafter, an embodiment will be specifically described with reference to the drawings.

The embodiment described below illustrates general or specific examples. Numeric values, shapes, materials, components, arrangement positions of components and connection forms thereof, steps, order of steps, and the like shown in the embodiment below are exemplary, and should not be construed as limitations to the present disclosure.

Moreover, among the components of the embodiments below, the components not described in an independent claim will be described as optional components.

The drawings are schematic views, and are not necessarily precise illustrations. In the drawings, identical referential signs are given to identical constituent components.

### Embodiment

### [Configuration]

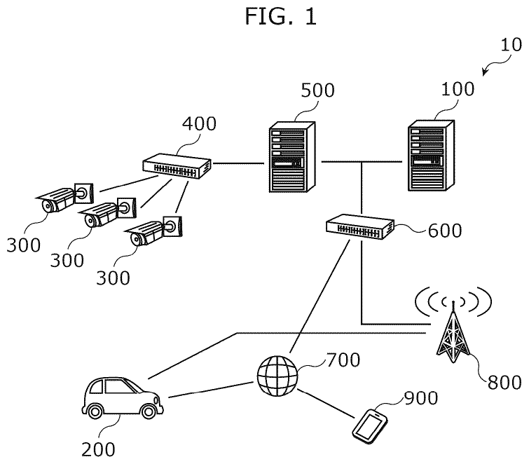

FIG. 1 is a diagram schematically illustrating mobile entity control system 10 according to an embodiment.

Mobile entity control system 10 is a system that causes mobile entity control device 100 to perform autonomous driving (autonomous traveling) of mobile entity 200. Autonomous driving refers to traveling of mobile entity 200, such as moving or parking, automatically or without an operation executed by a driver.

For example, mobile entity control system 10 includes mobile entity control device 100, mobile entity 200 capable of autonomous driving, camera 300, modems 400 and 600, and terminal 900. For example, mobile entity control device 100, mobile entity 200, and terminal 900 are communicably connected via network 700 such as the Internet and/or base station 800.

Camera 300 is a monitoring camera that is disposed in places where mobile entity 200 travels, such as roads or parking lots, and captures images of these places. The image captured by camera 300 is transmitted to monitoring server 500 via modem 400.

Mobile entity control system 10 may include one camera 300, or may include a plurality of cameras 300.

Monitoring server 500 is a server apparatus that calculates positions and moving directions of mobile entity 200 captured in the image and obstacles by image analysis of the image captured by camera 300.

Mobile entity control device 100 is a server apparatus that controls autonomous driving of mobile entity 200 via modem 600, network 700, and/or base station 800 based on the result of calculation by monitoring server 500. Hereinafter, control of autonomous driving of mobile entity 200 is simply also referred to as control of travel of mobile entity 200.

By operating terminal 900 which is a computer such as a smartphone, for example, a user transmits information indicating use of mobile entity 200, service contents requested by the user, such as the destination and the desired arrival time, and the position of the user to mobile entity control device 100 via network 700. For example, mobile entity control device 100 controls travel of mobile entity 200 by transmitting information indicating the driving route and the like via network 700 and/or base station 800 such that mobile entity 200 is moved to the position of the user based on the information received to arrive at the destination at the desired arrival time, that is, such that mobile entity 200 can provide service satisfying the service contents requested by the user.

Alternatively, for example, mobile entity control device 100 implements a so-called automated valet parking, that is, parking of mobile entity 200 in a parking lot by controlling mobile entity 200 based on a result of analysis of the image of mobile entity 200 by monitoring server 500. For example, mobile entity control device 100 causes mobile entity 200 to travel from an entrance of a parking lot to a parking space as the destination, and automatically parks mobile entity 200 in the parking space. Furthermore, mobile entity control device 100 causes mobile entity 200 parked in the parking space to travel to the entrance of the parking lot.

Mobile entity control system 10 may include one mobile entity 200, or may include a plurality of mobile entities 200.

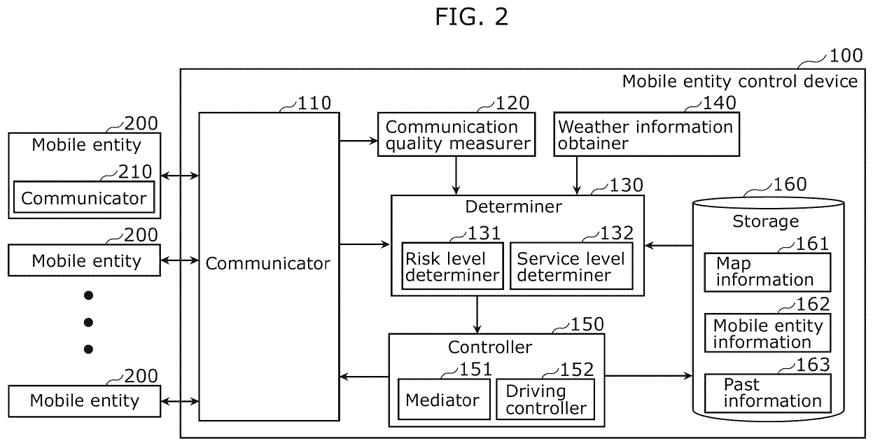

FIG. 2 is a block diagram illustrating the configuration of mobile entity control device 100 according to the embodiment.

Mobile entity control device 100 is a device that causes one or more mobile entities 200 to perform autonomous driving (traveling) by controlling one or more mobile entities 200. For example, mobile entity control device 100 is implemented by a computer including a communication interface for communicating with mobile entity 200, a non-volatile memory which stores programs, a volatile memory which is a temporary memory region for executing programs, and a processor which executes programs.

Mobile entity control device 100 includes communicator 110, communication quality measurer 120, determiner 130, controller 150, weather information obtainer 140, and storage 160.

Communicator 110 is a communication interface for communicating with mobile entity 200.

The communication path of communicator 110 for communicating with mobile entity 200 may be wired, may be wireless, or may be a combination thereof.

For example, communication between communicator 110 and base station 800 is wired communication. Communication between base station 800 and mobile entity 200 is wireless communication. The method of wireless communication may be Wi-Fi (registered trademark), Bluetooth (registered trademark), ZigBee, or specified low power radio, or may be any other communication method than these. In this case, for example, communicator 110 is implemented by a connector to which a communication cable is connected. Off course, communicator 110 may be implemented to be capable of performing wireless communication. In this case, communicator 110 is implemented by an antenna and a wireless communication circuit, for example.

Alternatively, communicator 110 may be configured to be communicable with terminal 900 and an external apparatus described later, for example.

Communication quality measurer 120 is a processor that measures quality (communication quality) of communication with mobile entity 200 via communicator 110.

For example, communication quality measurer 120 measures (calculates) the delay time of communication between mobile entity 200 and communicator 110 as communication quality. Specifically, communication quality measurer 120 initially extracts the transmission time included in information received by communicator 110. Next, communication quality measurer 120 calculates a difference between the current time and the extracted transmission time, and defines the calculated difference as the delay time. For example, communication quality measurer 120 calculates the difference as communication quality. For example, communication quality measurer 120 determines that a shorter delay time indicates better communication quality, and determines that a longer delay time indicates worse communication quality. Alternatively, for example, communication quality measurer 120 determines that the communication quality is good when the delay time is less than a predetermined threshold, and determines that the communication quality is bad when the delay time is equal to and greater than the predetermined threshold.

Mobile entity control device 100 may include a clock for measuring the current time, such as Real Time Clock (RTC), or may obtain time information indicating the current time from an external apparatus via communicator 110.

The predetermined threshold may be arbitrarily set, and is not Information indicating the predetermined particularly limited. threshold is preliminarily stored in storage 160, for example.

For example, communication quality measurer 120 determines the communication quality based on whether an anomaly is found in the information obtained from mobile entity 200 via communicator 110. For example, communication quality measurer 120 determines that the communication quality is good when no anomaly is found in the information obtained from mobile entity 200 via communicator 110, and determines that the communication quality is bad when an anomaly is found in the information obtained from mobile entity 200 via communicator 110.

Determinator 130 is a processor that determines a risk level and a service level. Determinator 130 includes risk level determiner 131 and service level determiner 132.

Risk level determiner 131 determines the risk level of specific locations in a predetermined driving route along which mobile entity 200 travels. In the present embodiment, the risk level is determined according to the communication quality measured by communication quality measurer 120.

The risk level indicates the degree of risk that an accident or the like occurs when mobile entity 200 travels. For example, a higher risk level indicates a higher risk, in other words, indicates lower safety. In contrast, for example, a lower risk level indicates a lower risk, in other words, indicates higher safety.

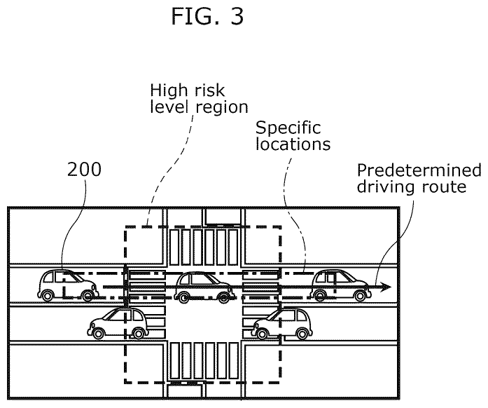

FIG. 3 is a diagram for illustrating a specific example of determination processing of determiner 130 according to the embodiment (more specifically, risk level determination processing by risk level determiner 131).

For example, based on information indicating the position of mobile entity 200, route information indicating the predetermined driving route, and map information 161, risk level determiner 131 initially determines a region from the current location of mobile entity 200 to 100 m ahead in the traveling direction to which mobile entity 200 is going to travel, as the specific locations. Next, as illustrated in FIG. 3, when the specific locations include a region having a high risk level, such as an intersection, (i.e., a region determined as having a high risk level), risk level determiner 131 determines to increase the risk level of the specific locations. For example, storage 160 preliminarily stores risk level determiner information that the intersection has a risk level of 8 on a scale of 1 to 10. Based on such information, risk level determiner 131 determines that the specific locations have a risk level of 8.

Thus, for example, risk level determiner 131 determines the risk level based on predetermined first information. Specifically, for example, risk level determiner 131 determines the risk level of the specific locations, based on the predetermined first information such as the route information indicating a predetermined driving route, driving information such as the driving speed and the rudder angle of mobile entity 200, information indicating the communication quality of communication with mobile entity 200 via communicator 110, past information 163 which is driving control information generated by controller 150 in the past described later, mobile entity information 162 including pieces of information concerning one or more mobile entities 200 controlled by mobile entity control device 100, map information 161 indicating a map including the predetermined driving route, and weather information in the driving route along which mobile entity 200 travels.

The pieces of information concerning one or more mobile entities 200 controlled by mobile entity control device 100, which are included in mobile entity information 162, each may include information concerning attributes such as the width, the height, the length, and acceleration/deceleration performance of mobile entity 200, and information concerning the states of mobile entity 200 such as the usage state of mobile entity 200, the distance to empty, the current location, and the position of the destination.

The predetermined first information may be one of the above-mentioned pieces of information, or may be two or more of them, for example.

As described above, the predetermined driving route is calculated based on the position and destination of the user obtained from terminal 900, for example. The information indicating the predetermined driving route may be calculated by mobile entity control device 100, or may be calculated by mobile entity 200 and transmitted to mobile entity control device 100.

The specific locations may be arbitrarily set, and is not particularly limited. One specific location may be set for the predetermined driving route, or a plurality of specific locations may be set for the predetermined driving route. For example, a plurality of specific locations may be set for each of predetermined intervals in the predetermined driving route. Alternatively, for example, the predetermined driving route may be divided into paths, and the risk level may be determined for each of the paths as the specific locations.

Service level determiner 132 determines the service level of a service provided by mobile entity 200. As described above, for example, mobile entity control device 100 obtains information indicating service contents requested by the user from terminal 900 or the like, and calculates the driving route and the like based on the obtained information. Here, the service contents include cases where mobile entity 200 should provide a service which is difficult for mobile entity 200 to provide, for example, cases where the desired arrival time is close to the current time, or cases where mobile entity 200 should travel on complicated roads until it arrives at the destination. For example, service level determiner 132 determines the service level indicating the degree of difficulty of such a service. For example, as the service level is higher, the content of the service requested is more difficult to implement. In contrast, for example, as the service level is lower, the content of the service requested is easier to implement.

For example, service level determiner 132 determines the service level based on predetermined second information. Specifically, for example, service level determiner 132 determines the service level, based on the predetermined second information such as information indicating the service content, route information indicating a predetermined driving route, driving information such as the driving speed and the rudder angle of mobile entity 200, information indicating the communication quality, past information 163 which is driving control information generated by controller 150 in the past described later, mobile entity information 162 including pieces of information concerning one or more mobile entities 200 controlled by mobile entity control device 100, map information 161 indicating a map including the predetermined driving route, and weather information in the driving route along which mobile entity 200 travels.

The pieces of information concerning one or more mobile entities 200 controlled by mobile entity control device 100, which are included in mobile entity information 162 used by service level determiner 132 in determination, each may include information concerning attributes such as the width, the height, the length, and acceleration/deceleration performance of mobile entity 200, and information concerning the states of mobile entity 200 such as the usage state of mobile entity 20.

The predetermined second information may be one of the above-mentioned pieces of information, or may be two or more of them, for example.

The predetermined first information may be the same as the predetermined second information, or may be different from the predetermined second information. Determiner 130 obtains the predetermined first information and the predetermined second information, and determines (calculates) the risk level and the service level using the predetermined first information and predetermined second information obtained. For example, the driving information of mobile entity 200 and the information indicating the service content are obtained from mobile entity 200 or terminal 900 via communicator 110. For example, map information 161, mobile entity information 162, and past information 163 are stored in storage 160, and are obtained from storage 160. For example, the weather information is obtained by weather information obtainer 140.

For example, determiner 130 determines at least one of the risk level or the service level based on past information 163 including the driving control information generated by controller 150 in the past.

In such a configuration, when controller 150 generates the driving control information and the risk level and/or the service level under the same condition as that when it generated the driving control information in the past, for example, by referring to the driving control information from the past, determiner 130 can improve determination precision (processing precision) of the risk level and/or determination precision of the service level, or improve their determination speeds (processing speeds).

Past information 163 may further include information used to generate the driving control information (specifically, driving control information generated by controller 150 in the past). The information is, for example, the information indicating the communication quality, the information indicating the risk level, and the information indicating the service level.

In such a configuration, when controller 150 generates the driving control information and the risk level and/or the service level under the same condition as that when it generated the driving control information in the past, for example, by referring to the driving control information from the past and the information used to generate the driving control information, determiner 130 can improve the determination precision of the risk level and/or the determination precision of the service level, and improve their determination speeds.

For example, determiner 130 determines at least one of the risk level or the service level based on mobile entity information 162 including the information concerning a plurality of mobile entities 200 with which mobile entity control device 100 communicates.

As described above, the pieces of information concerning one or more mobile entities 200 controlled by mobile entity control device 100, which are included in mobile entity information 162 used in determination by determiner 130, each may include information concerning attributes such as the width, the height, the length, and acceleration/deceleration performance of mobile entity 200, and information concerning the states of mobile entity 200 such as the usage state of mobile entity 20.

The pieces of information concerning the plurality of mobile entities 200 are each information such as the predetermined first information and the predetermined second information of each of the plurality of mobile entities 200.

In such a configuration, when controller 150 generates the driving control information of one mobile entity 200 under the same condition as that when the driving control information of another mobile entity 200 is generated, for example, by referring to the driving control information of another mobile entity 200, determiner 130 can improve the determination precision of the risk level and/or the determination precision of the service level, and improve their determination speeds.

For example, determiner 130 determines at least one of the risk level or the service level based on map information 161 indicating a map including the predetermined driving route.

In such a configuration, determiner 130 can determine the risk level and/or the service level in consideration of the information which is likely to affect the travel of mobile entity 200, such as intersections, downgrades, narrow roads, sharp bends, and railroad crossings.

For example, determiner 130 determines at least one of the risk level or the service level based on the weather information. The weather information is, for example, information of the weather, such as rain or shine, and the air temperature in the predetermined driving route.

In such a configuration, determiner 130 can determine the risk level and/or the service level in consideration of information that is likely to affect the travel of mobile entity 200, such as rain or snow or a state at a low air temperature.

For each of the risk level and the service level, a plurality of levels can be set, which may be two levels, or may be three or more levels. The rankings set for the risk level and those set for the service level may be the same such as levels 1 to 10, or may be different.

Weather information obtainer 140 is a processor that obtains the weather information. For example, weather information obtainer 140 obtains the weather information from an external apparatus via communicator 110, the weather information indicating the current weather and the air temperature in the predetermined driving route.

For example, determiner 130 (risk level determiner 131) determines to reduce the risk level when the weather indicated by the weather information is shine, and determines to increase the risk level when the weather indicated by the weather information is rain or snow.

Controller 150 is a processor that generates information (driving control information) for driving mobile entity 200, based on the communication quality measured by communication quality measurer 120 and the result of determination by determiner 130. Specifically, controller 150 generates the driving control information for controlling travel of mobile entity 200 based on the communication quality and the risk level, and transmits the driving control information to mobile entity 200 via communicator 110. Thereby, mobile entity 200 travels based on the driving control information.

In such a configuration, mobile entity control device 100 can control the travel of mobile entity 200 using not only the communication quality of communication between mobile entity control device 100 and mobile entity 200 but also the risk level (degree of risk) of the position through which mobile entity 200 travels (passes). For this reason, the safety of autonomous driving of mobile entity 200 can be improved, compared to a traditional device which controls travel of mobile entity 200 in consideration of only the communication quality of communication with mobile entity 200.

The driving control information is data for causing mobile entity 200 to travel along the predetermined driving route. For example, the driving control information includes information indicating the current location of mobile entity 200, the position of the destination, the desired arrival time at which mobile entity 200 arrives at the destination, the predetermined driving route, and the driving speed. In the present embodiment, controller 150 generates the driving control information based on the communication quality, the risk level, and the service level.

In some cases, mobile entity 200 is required to provide a service to deliver the user to the destination until a predetermined time, for example. It is considered that such a service includes a case where the user should be delivered in a very short time and a case where the user is delivered with time to spare, and the service level required for the service is different depending on the case. Thus, by controlling the travel of mobile entity 200 also in consideration of the service level, an unnecessary reduction in quality of the service provided by mobile entity 200, such as an unnecessary deceleration of mobile entity 200, can be suppressed.

Here, for example, when the service level is extremely high and the risk level is extremely low, the driving control information is generated to provide the service in the requested service content without considering the risk. Thereby, in some cases, the driving control information can be generated with a reduced amount of processing while the safety of autonomous driving of mobile entity 200 is ensured. As in these cases, controller 150 may generate the driving control information in consideration of only one of the service level and the risk level. In other words, for example, controller 150 selects either the risk level or the service level based on the risk level and the service level, and generates the driving control information based on the selected one of the risk level or the service level. For example, controller 150 selects either the risk level or the service level by comparing the risk level to the service level.

In such a configuration, controller 150 can generate the driving control information with a reduced amount of processing.

In the present embodiment, controller 150 includes mediator 151 and driving controller 152.

Mediator 151 selects either the risk level or the service level by comparing the risk level to the service level. Specifically, mediator 151 selects either the risk level or the service level, and generates driving restriction information indicating a result of selection.

Driving controller 152 generates the driving control information based on the driving restriction information generated by mediator 151. Specifically, driving controller 152 generates the driving control information in consideration of either the risk level or the service level based on the driving restriction information.

Depending on the risk level and the service level, by changing the driving route of mobile entity 200, the risk of autonomous driving of mobile entity 200 is more likely to be reduced, or mobile entity 200 can more easily provide the service in some cases. For example, when one driving route has the shortest distance to the destination but mobile entity 200 is slowed down in consideration of the risk level, for example, there are some cases where depending on the driving route, mobile entity 200 can arrive at the destination in a shorter time while the safety of autonomous driving thereof is ensured, for example, by causing mobile entity 200 to travel on another driving route. Thus, controller 150 calculates a new driving route based on at least the selected one of the risk level or the service level, and generates the driving control information to change the driving route of mobile entity 200 from the predetermined driving route to the new driving route.

In such a configuration, by calculating the new driving route based on the risk level and/or the service level, controller 150 can improve the safety of autonomous driving of mobile entity 200 or cause mobile entity 200 to provide the service appropriately.

The processors such as communication quality measurer 120, determiner 130, weather information obtainer 140, and controller 150 are implemented by one or more memories that store control programs, and one or more processors that execute the control programs, for example.

Storage 160 is a recording medium for storing driving control information generated by controller 150 and the like. For example, storage 160 is a hard disk drive, a random access memory (RAM), a read only memory (ROM), or a semiconductor memory.

For example, storage 160 stores map information 161, mobile entity information 162, and past information 163.

Map information 161 is information indicating the map of places where mobile entity 200 travels.

Mobile entity information 162 is information including the driving control information for controlling mobile entity 200.

Mobile entity information 162 includes driving control information for controlling one or more mobile entities 200 controlled by mobile entity control device 100.

Past information 163 is information including the driving control information from the past. Past information 163 can be the driving control information generated by controller 150 in the past or information generated from the driving control information, and may be statistic information calculated from pieces of driving control information generated by controller 150 in the past, for example.

Storage 160 may be volatile, or may be non-volatile.

Mobile entity 200 is a mobile entity capable of autonomous driving. In the present embodiment, mobile entity 200 is a vehicle such as an automobile equipped with a telematics control unit (TCU). Mobile entity 200 includes a sensor that detects obstacles in the vicinity of mobile entity 200, such as a camera or an ultrasonic sensor; an actuator such as a motor and an engine; a control device that controls travel of mobile entity 200 by controlling these actuators, such as a processor; and communicator 210 for communicating with mobile entity control device 100. The control device obtains the driving control information from mobile entity control device 100 via communicator 210, obtains the result of detection by the sensor, and causes mobile entity 200 to perform automatic driving based on the driving control information and the result of detection.

Mobile entity control device 100 may control one mobile entity 200, or may control a plurality of mobile entities, and the number thereof is not particularly limited.

When mobile entity control device 100 controls a plurality of mobile entities 200, mobile entity control device 100 executes the above-mentioned processing for each of mobile entities 200. Thereby, for example, mobile entity information 162 includes pieces of information concerning the plurality of mobile entities 200 controlled by mobile entity control device 100. Past information 163 includes pieces of driving control information generated by mobile entity control device 100 in the past for the plurality of mobile entities 200.

### [Processing Procedure]

Subsequently, the processing procedure of mobile entity control device 100 will be described.

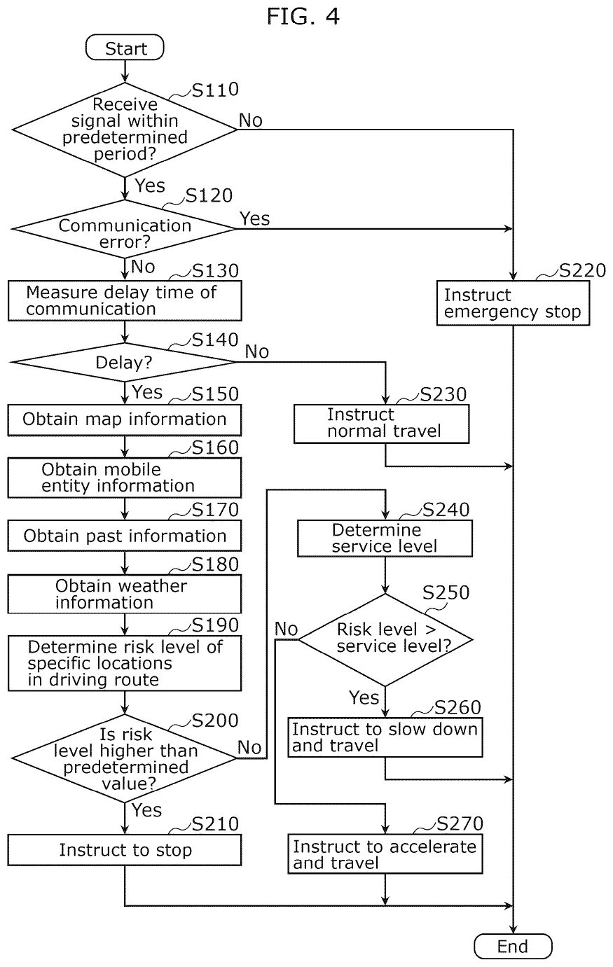

FIG. 4 is a flowchart illustrating the processing procedure of mobile entity control device 100 according to the embodiment.

By transmitting a predetermined signal in a predetermined circle between mobile entity control device 100 and mobile entity 200, mobile entity control device 100 and mobile entity 200 verify whether mobile entity control device 100 and mobile entity 200 appropriately communicate with each other. As described above, for example, mobile entity control device 100 obtains information indicating the service content from terminal 900, the information being requested by the user, and calculates the driving route and the like based on the obtained information, and transmits the result of calculation to mobile entity 200. Mobile entity 200 determines the driving speed and the rudder angle based on the result of detection by a camera and a distance measurement sensor (not illustrated) included in mobile entity 200, and starts autonomous driving based on the received result of calculation.

Initially, communication quality measurer 120 determines whether the signal is received within a predetermined period (S110). In other words, communication quality measurer 120 determines whether the signal can be received from mobile entity 200 in a predetermined cycle.

When communication quality measurer 120 determines that the signal is not received within the predetermined period (No in S110), that is, when communication quality measurer 120 determines that the communication quality of communication with mobile entity 200 is bad, controller 150 generates driving control information including an instruction to cause mobile entity 200 to perform an emergency stop, and transmits the generated driving control information to mobile entity 200 (S220). Thereby, controller 150 causes mobile entity 200 to perform an emergency stop to immediately stop on the spot, for example.

The communication quality may be also determined in mobile entity 200. For example, mobile entity 200 may perform emergency stop when communication is impossible, a communication error occurs, or communication delay is equal to or greater than a threshold in communication with mobile entity control device 100. For example, mobile entity control device 100 transmits driving control information indicating an instruction to cause mobile entity 200 to perform an emergency stop to mobile entity 200 when communication is impossible, a communication error occurs, or communication delay is equal to or greater than a threshold in communication with mobile entity 200. In this case, even if a response to the transmission of the driving control information to mobile entity 200 is not transmitted from mobile entity 200, mobile entity control device 100 can consider that mobile entity 200 has performed the emergency stop.

In contrast, when communication quality measurer 120 determines that the signal is received within a predetermined period (Yes in S110), communication quality measurer 120 determines whether an communication error occurs in communication with mobile entity 200 (S120). For example, communication quality measurer 120 determines whether the signal received from mobile entity 200 has an anomaly.

When communication quality measurer 120 determines that a communication error occurs in communication with mobile entity 200 (Yes in S120), that is, when communication quality measurer 120 determines that the communication quality of communication with mobile entity 200 is very bad, controller 150 generates driving control information indicating an instruction to cause mobile entity 200 to perform an emergency stop, and transmits the generated driving control information to mobile entity 200 (S220). Thereby, controller 150 causes mobile entity 200 to perform emergency stop.

In contrast, when communication quality measurer 120 determines that no communication error occurs in communication with mobile entity 200 (No in S120), communication quality measurer 120 measures the delay time in communication with mobile entity 200 (S130). For example, communication quality measurer 120 extracts the transmission time included in the information received by communicator 110, calculates the difference between the current time and the extracted transmission time, and measures the delay time as the calculated difference.

Next, based on the calculated delay time, communication quality measurer 120 determines whether a delay is present in communication with mobile entity 200 (S140). For example, communication quality measurer 120 determines whether the calculated delay time is equal to or more than a predetermined time. The predetermined time may be preliminarily set at any value, and is not particularly limited. The information indicating the predetermined time is stored in storage 160, for example.

When communication quality measurer 120 determines that no delay is present in communication with mobile entity 200 (No in S140), that is, when communication quality measurer 120 determines that the communication quality of communication with mobile entity 200 is good, controller 150 generates driving control information indicating to an instruction to cause mobile entity 200 to normally travel, and transmits the generated driving control information to mobile entity 200 (S230). Thereby, controller 150 causes mobile entity 200 to travel without performing unnecessary stop or deceleration.

For example, in the case where it is set such that mobile entity 200 normally travels when mobile entity 200 does not receive the instruction indicating the emergency stop executed in step S220, step S230 may not be executed.

In contrast, when communication quality measurer 120 determines that a delay is present in communication with mobile entity 200 (Yes in S140), that is, when communication quality measurer 120 determines that the communication quality of communication with mobile entity 200 is not good although it is not a level to perform emergency stop of mobile entity 200, communication quality measurer 120 obtains a variety of pieces of information for calculating the risk level. For example, determiner 130 obtains map information 161 from storage 160 (S150). For example, determiner 130 obtains mobile entity information 162 from storage 160 (S160). For example, determiner 130 obtains past information 163 from storage 160 (S170). For example, determiner 130 obtains the weather information obtained by weather information obtainer 140 (S180).

Next, based on these pieces of information obtained, determiner 130 determines the risk level of the specific locations in the driving route of mobile entity 200 (S190).

Next, determiner 130 determines whether the calculated risk level is higher than a predetermined value (S200). The predetermined value may be preliminarily set to any value, and is not particularly limited. The information indicating the predetermined value is preliminarily stored in storage 160, for example.

When determiner 130 determines that the calculated risk level is higher than the predetermined value (Yes in S200), that is, when determiner 130 determines that travel of mobile entity 200 is highly risky, controller 150 generates driving control information including an instruction to cause mobile entity 200 to stop, and transmits the generated driving control information to mobile entity 200 (S210). For example, controller 150 obtains map information 161 and information indicating the current location of mobile entity 200, and identifies a spot where mobile entity 200 can be caused to safely stop, based on these pieces of information obtained. Furthermore, for example, controller 150 generates driving control information for causing mobile entity 200 to stop at the identified spot, and transmits the generated driving control information to mobile entity 200 via communicator 110. Thereby, controller 150 causes mobile entity 200 to stop at a spot where mobile entity 200 can be caused to safely stop, for example.

In contrast, for example, when determiner 130 determines that the calculated risk level is equal to or lower than the predetermined value (No in S200), that is, when determiner 130 determines that it is unnecessary to stop mobile entity 200, determiner 130 determines the service level of the service requested for mobile entity 200 (S240). For example, based on a variety of pieces of information obtained in steps S150 to S180, determiner 130 determines the service level.

When one or more pieces of information are different between pieces of information used to calculate the risk level and those used to calculate the service level, determiner 130 may further obtain information used to calculate the service level before determining the service level.

Next, determiner 130 determines whether the risk level is higher than the service level (S250).

When determiner 130 determines that the risk level is higher than the service level (Yes in S250), that is, when determiner 130 determines that it is better to control travel of mobile entity 200 in consideration of the risk in autonomous driving of mobile entity 200 rather than the service requested for mobile entity 200, controller 150 generates driving control information including an instruction to cause mobile entity 200 to slow down from the normal driving speed, and transmits the generated driving control information to mobile entity 200 (S260). Thereby, for example, controller 150 causes mobile entity 200 to travel at a speed lower than the driving speed instructed to mobile entity 200 in step S230.

The speed after the deceleration of mobile entity 200 may be set in any manner. For example, controller 150 may determine the speed to be lowered to, according to the risk level. For example, controller 150 may determine the speed to further slow down mobile entity 200 as the risk level is higher.

In contrast, when determiner 130 determines that the risk level is equal to or lower than the service level (No in S250), that is, when determiner 130 determines that it is better to control travel of mobile entity 200 in consideration of the service requested for mobile entity 200 rather than the risk in autonomous driving of mobile entity 200, controller 150 generates driving control information indicating an instruction to cause mobile entity 200 to accelerate, and transmits the generated driving control information to mobile entity 200 (S270). Thereby, for example, controller 150 causes mobile entity 200 to travel at a speed higher than the driving speed instructed to mobile entity 200 in step S230 or S260.

In step S270, for example, controller 150 may generate the driving control information to cause mobile entity 200 to travel at a speed higher than the normal driving speed instructed to mobile entity 200 in step S230.

The speed of mobile entity 200 instructed in step S270 may be set in any manner. For example, controller 150 may determine the speed to be accelerated or slowed down, according to the service level. For example, controller 150 may determine the speed to cause mobile entity 200 to travel at a higher speed as the service level is higher.

### [Summary]

As described above, mobile entity control device 100 according to the embodiment includes communicator 110 for communicating with a mobile entity capable of autonomous driving, communication quality measurer 120 that measures communication quality of communication with mobile entity 200 via communicator 110, determiner 130 that determines a risk level of specific locations in a predetermined driving route along which mobile entity 200 travels, and controller 150 that generates driving control information for controlling travel of mobile entity 200 based on the communication quality and the risk level, and transmits the generated driving control information to mobile entity 200 via communicator 110.

Thus, mobile entity control device 100 controls the travel of mobile entity 200 not only using the communication quality of communication with mobile entity 200 but also using the risk level of the location where mobile entity 200 travels. Thereby, mobile entity control device 100 can suppress obstacles to smooth travel of mobile entity 200, and can improve the safety of autonomous driving of mobile entity 200. For example, in PTL 1 described above, the vehicle is controlled using only the current communication quality measured value of the own vehicle. For this reason, similar instructions of deceleration and/or stop may be performed every time in a path at a time zone. In contrast, for example, even if the communication quality is the same, mobile entity control device 100 generates the driving control information to increase operational efficiency, for example, to increase the safety for a high risk level, and to cause the mobile entity to arrive at the destination for a low risk level. For example, mobile entity control device 100 generates the driving control information to lower the speed of mobile entity 200 in an intersection even if the communication quality is not so bad. Thereby, mobile entity control device 100 controls the travel of mobile entity 200 to increase the operational efficiency as smoothly as possible while maintaining the safety of autonomous driving of mobile entity 200.

Mobile entity control device 100 generates the driving control information using the risk level. For example, the risk level is determined using the current location of mobile entity 200 and map information 161. Specifically, for example, mobile entity control device 100 generates the driving control information using the risk level of a location of a high risk to the travel of mobile entity 200 on the driving route of mobile entity 200, such as an intersection, a downgrade, a narrow road, a sharp bend, or a railroad crossing, and a possibility that the risk may occur.

In such a configuration, mobile entity control device 100 can determine the risk level in consideration of the information considered to be likely to affect the travel of mobile entity 200.

In addition, the driving control information may be generated using a service level to be satisfied by each mobile entity 200 in an area managed (e.g., an area in which the travel of mobile entity 200 is controlled). The service level is determined using mobile entity information 162 stored in storage 160, for example. For example, mobile entity information 162 is also used in determination of the risk level.

The risk level and/or the service level may be determined using a distance to an obstacle located in the vicinity of mobile entity 200, such as other mobile entity 200, and the moving velocity of the obstacle.

In addition, mobile entity control device 100 may store the driving control information transmitted to mobile entity 200 in the past, that is, may store the driving control information generated in the past as past information 163 which is statistic information with respect of each mobile entity 200, each time, and each place. Past information 163 may also be used in determination of the risk level and/or the service level.

In such a configuration, mobile entity control device 100 can improve the determination precision of the risk level and/or the determination precision of the service level, or can improve these determination speeds.

For example, the risk level and/or the service level may be determined in consideration of (i) weather information obtained by weather information obtainer 140 (more specifically, the weather situation indicated by the weather information), and/or (ii) the braking distance from reception of the driving control information by mobile entity 200 to completion of control of the travel, the braking distance being calculated using a result of prediction based on the weather information, such as the road surface situation on the driving route.

For example, when mobile entity control device 100 determines based on the above-mentioned risk level (and the service level) that it is necessary to cause mobile entity 200 which is traveling to stop to a spot, mobile entity control device 100 generates driving control information for causing mobile entity 120 to stop to the spot, and transmits it to mobile entity 200. Further, for example, when mobile entity control device 100 determines that it is necessary to cause mobile entity 200 to immediately stop, for example, when an obstacle is detected near mobile entity 200, based on the above-mentioned risk level (and the service level), mobile entity control device 100 generates driving control information to cause mobile entity 200 to perform emergency stop, and transmits it to mobile entity 200.

Mobile entity control device 100 may search for a driving route in which one or both of the risk level and the service level are good, generate driving control information for rerouting the driving route of the mobile entity from the predetermined driving route to a new driving route, and transmit it to mobile entity 200.

Moreover, general or specific aspects according to the present disclosure may be implemented by a system, a method, an integrated circuit, a computer program, or a recording medium such as a computer-readable CD-ROM, or may be implemented by any combination of systems, methods, integrated circuits, computer programs, and recording media.

For example, the present disclosure may be implemented as a mobile entity control method of measuring communication quality of communication with mobile entity 200 via communicator 110 for communicating with mobile entity 200 capable of autonomous driving (e.g., S110 to S140), determining a risk level of specific locations in a predetermined driving route along which mobile entity 200 travels (S190), generating driving control information for controlling travel of mobile entity 200 based on the communication quality and the risk level, and transmitting the driving control information to mobile entity 200 via communicator 110 (e.g., S210 to S230, S260, and S270).

For example, when the communication quality is equal to or lower than a first communication quality (that is, the communication quality is bad), as in the case of No in step S110 or Yes in step S120, driving control information for causing mobile entity 200 to perform emergency stop is generated. For example, when the communication quality is higher than the first communication quality and is equal to or lower than a second communication quality, that is, Yes in step S140, for example, the driving control information is generated based on the risk level. For example, when the communication quality is higher than the second communication quality (that is, the communication quality is good), as in the case of step No in S140, driving control information for causing mobile entity 200 to normally travel is generated.

For example, when the risk level is higher than a predetermined value (Yes in S200), mobile entity control information for causing travel of mobile entity 200 to stop is generated. In contrast, when the risk level is equal to or lower than the predetermined value (No in S200), the service level is determined (S240), and the mobile entity control information is generated also based on the service level. Specifically, for example, the risk level is compared to the service level (S250), and the driving control information is generated based on only one of the risk level and the service level whose level is higher (step S260 or S270). When the risk level and the service level are the same level, the determination in step S250 may be Yes, or may be No.

### Other Embodiments

Thus, the mobile entity control device according to one or a plurality of aspects has been described based on the embodiment above, but the present disclosure is not limited to the embodiment above. The present disclosure may also cover embodiments obtained by subjecting the embodiment above to a variety of modifications conceived by persons skilled in the art without departing from the gist of the present disclosure.

For example, determiner 130 need not use the weather information in the above-mentioned determination processing. In this case, mobile entity control device 100 need not include weather information obtainer 140.

For example, determiner 130 need not determine the service level. In this case, determiner 130 need not include service level determiner 132.

For example, in the case of No in step S140, that is, when the communication quality is good without a delay in communication between mobile entity control device 100 and mobile entity 200, mobile entity control device 100 may execute steps S150 to S190 and S240, and determine the driving speed of mobile entity 200 according to the risk level and the service level. For example, when the service level is higher than the risk level by a level equal to or higher than a predetermined level, mobile entity control device 100 may transmit driving control information indicating an instruction to cause mobile entity 200 to travel at a higher speed than as usual to mobile entity 200.

For example, in the case of No in step S140, that is, when the risk level is equal to or higher than a predetermined risk level even if the communication quality is good without a delay in communication between mobile entity control device 100 and mobile entity 200, mobile entity control device 100 may generate mobile entity control information for causing mobile entity 200 to slow down or stop or for generating a new driving route and changing the predetermined driving route to the new driving route.

For example, in the embodiment above, the processing executed by a specific processor may be executed by another processor. Moreover, the order of a plurality of processings may be changed, or a plurality of processings may be executed concurrently. For example, in the embodiment above, the components of the processors such as determiner 130 and controller 150 may be configured of their dedicated hardware, or may be implemented by executing software programs suitable for the components. The components may be implemented by a program executer, such as a central processing unit (CPU) or a processor, reading out and executing software programs recorded on a recording medium such as a hard disk or semiconductor memory. Here, the programs that implement the devices according to the embodiment above cause a computer to execute the steps in the flowchart illustrated in FIG. 4, for example.

The present disclosure also covers the following cases.
(1) Specifically, the devices above are a computer system configured of a microprocessor, a ROM, a RAM, a hard disk unit, a display unit, a keyboard, a mouse, and the like. The RAM or the hard disk unit stores computer programs. When the microprocessor operates according to the computer programs, the devices achieve their functions. Here, the computer programs are each configured of a combination of command codes to give instructions to a computer to achieve predetermined functions.
(2) Part or all of the components constituting each of the devices may be configured of a single system LSI (Large Scale Integration: large scale integrated circuit). The system LSI is an ultra-multifunctional LSI produced by integrating a plurality of constituents on a single chip, and specifically is a computer system including a microprocessor, a ROM, and a RAM. The RAM stores computer programs. When the microprocessor operates according to the computer programs, the system LSI achieves its functions.
(3) Part or all of the components constituting the devices may be configured of an IC card or a single module which is detachably attachable to the devices. The IC card or the module is a computer system configured of a microprocessor, a ROM, a RAM, and the like. The IC card or the module may include the above ultra-multifunctional LSI. When the microprocessor operates according to a computer program, the IC card or the module achieves its functions. This IC card or module may have tamper proofness.
(4) The present disclosure may be the methods described above. These methods may be a computer program implemented by causing a computer to execute these, or may be digital signals composed of the computer program.

The present disclosure may be the computer program or the digital signals recorded on a computer-readable recording medium, such as a flexible disc, a hard disk, a CD-ROM, a MO, a DVD, a DVD-ROM, a DVD-RAM, a Blu-ray (registered trademark) Disc (BD), or a semiconductor memory. The present disclosure may also be the digital signals recorded on these recording media.

The present disclosure may be the computer program or the digital signals transmitted via an electrical communication line, a wireless or wired communication line, a network such as the Internet, or data broadcasting.

The program or the digital signals may be implemented by another independent computer system by recording the program or the digital signals on a recording medium and transferring the recording medium or by transferring the program or the digital signals via a network or the like.

### Further Information About Technical Background to This Application

The disclosures of the following patent applications including specification, drawings, and claims are incorporated herein by reference in their entirety: Japanese Patent Application No. 2022-055139 filed on Mar. 30, 2022, and PCT International Application No. PCT/JP2022/047068 filed on Dec. 21, 2022.

### INDUSTRIAL APPLICABILITY

The present disclosure can be used in devices that control travel of vehicles capable of autonomous driving, for example.

1. A mobile entity control device comprising:
a communication circuit that communicates with a mobile entity capable of autonomous driving;
a communication quality measurement circuit that measures communication quality of communication with the mobile entity via the communication circuit;
a determination circuit that determines a risk level of specific locations in a predetermined driving route along which the mobile entity travels; and
a control circuit that generates driving control information for controlling travel of the mobile entity based on the communication quality and the risk level, and transmits the driving control information to the mobile entity via the communication circuit.

2. The mobile entity control device according to claim 1,
wherein the determination circuit further determines a service level of a service provided by the mobile entity, and
the control circuit generates the driving control information based on the communication quality, the risk level, and the service level.

3. The mobile entity control device according to claim 2,
wherein the determination circuit determines at least one of the risk level or the service level based on past information including the driving control information from a past.

4. The mobile entity control device according to claim 3,
wherein the past information further includes information used to generate the driving control information.

5. The mobile entity control device according to claim 2,
wherein the determination circuit determines at least one of the risk level or the service level based on mobile entity information including pieces of information concerning a plurality of mobile entities with which the mobile entity control device communicates, each of the plurality of mobile entities being the mobile entity.

6. The mobile entity control device according to claim 2,
wherein the determination circuit determines at least one of the risk level or the service level based on map information indicating a map including the predetermined driving route.

7. The mobile entity control device according to claim 2,
wherein the determination circuit determines at least one of the risk level or the service level based on weather information.

8. The mobile entity control device according to claim 2,
wherein the control circuit:
selects either the risk level or the service level based on the risk level and the service level; and
generates the driving control information based on a selected one of the risk level or the service level.

9. The mobile entity control device according to claim 8,
wherein the control circuit:
calculates a new driving route based on at least the selected one of the risk level or the service level; and
generates the driving control information to change a driving route of the mobile entity from the predetermined driving route to the new driving route.

10. A mobile entity control method comprising:
measuring communication quality of communication with a mobile entity capable of autonomous driving via a communication circuit for communicating with the mobile entity;
determining a risk level of specific locations in a predetermined driving route along which the mobile entity travels; and
generating driving control information for controlling travel of the mobile entity based on the communication quality and the risk level, and transmitting the driving control information to the mobile entity via the communication circuit.
